(19) United States
(12) Patent Application Publication
(10) Pub. No.: US 2004/0148236 A1
(43) Pub. Date: Jul. 29, 2004

(54) Leveraged supply contracts

(76) Inventor: J. Peter Steidlmayer, Wilmette, IL (US)

Correspondence Address: FOLEY & LARDNER, 321 NORTH CLARK STREET, SUITE 2800, CHICAGO, IL, 60610-4764, US

(21) Appl. No.: 10/351,949

(22) Filed: Jan. 27, 2003

(51) Int. Cl. G06F 17/60

(52) U.S. Cl. 705/35

(57) ABSTRACT

An improved form of commodities contract that provides for a better economic basis than conventional contracts due to a leveraged design focus. Instead of focusing primarily on price, contracts according to the present invention emphasize the supply and usage of the underlying referenced commodity or product, creating a mechanism by which entities having an active interest in the underlying referenced commodity can take advantage of structured leverage, while also being beneficial to both the buyer and seller.

### FIELD OF THE INVENTION

The present invention relates generally to an improved contract that can be traded based upon leveraged supply.

### BACKGROUND OF THE INVENTION

A variety of different types of contracts are traded on various commodity exchanges and other markets throughout the world. A cash contract is a sales agreement for either immediate or deferred delivery of the actual commodity. An option is a contract that conveys the right, but not the obligation, to buy or sell a particular commodity or futures contract on a commodity at a certain price for a limited time. A call option is an option that gives the buyer the right, but not the obligation, to purchase the underlying commodity or futures contract at a certain price (known as the strike price) on or before the expiration date. A put option is an option that gives the option buyer the right, but not the obligation, to sell the underlying commodity or futures contract at the strike price on or before the expiration date.

A futures contract is a legally binding agreement, typically entered into on or pursuant to the rules of a commodity exchange, to buy or sell a commodity (which may be a financial instrument) sometime in the future. A commodity is generally an article of commerce or a product that can be used for commerce. In a narrow sense not intended for use herein, futures and options contracts for commodities are products traded on a formally organized commodity exchange. The types of commodities commonly include agricultural products such as corn, soybeans and wheat; precious metals such as gold; fuels such as petroleum; foreign currencies such as the Euro; financial instruments such as U.S. Treasury securities and financial indexes such as the Standard & Poor's 500 stock index, to name a few. Unlike cash commercial contracts, futures contracts very rarely result in delivery, because most are liquidated by offsetting positions prior to expiration.

A common feature of these standard contracts is that the differential is based on price. For example, futures contracts are standardized according to the quality, quantity, duration, and delivery time and location for each commodity. The quality, quantity, duration, and delivery time and location for each contract are fixed so that the price becomes the single variable. This is due to the fact that standard contracts are designed in order to achieve maximum liquidity: if several elements were variable, the contract would be exceedingly volatile and therefore practically untradable.

The prices applied to these standard contracts are universal in that they convey the same messade to participants as well as those on the sideline who are not involved in a particular transaction: the collective view of market users on how to measure or assess current risk within the market as a whole for the underlying referenced commodity. The relationship of supply-to-price in standard contracts is one where price measures the current or cumulative risk related to that supply, allowing individuals to assess price versus their particular needs (price discovery). Over the years, the risk chain associated with supply has grown dramatically in the number and magnitude of risks. The normal situation for referenced supply is to have a price-measured risk from the elements of the risk chain. It is the shifting of related supply risks to various influences that makes price available to risk reduction and market access. This is called random activity. It is the basis of liquidity, which is so desirous in standard contracts.

The increased risk chain has made it very difficult to isolate reduction of risk so that opportunity can be greater than cost. Thus, standard contracts are mostly adversarial in nature in that what is a good result for one party is bad for the other; in other words, standard contracts represent a “zero-sum” effect where cost of access is greater than the opportunity. Many different types of risks are assumed upon activation of the contract, and the risks fully apply until cancellation of the contract. It is the new larger risks within the risk chain that are the most difficult with which to deal as they have to be given credence despite a small chance of occurring. Some of the types of risk will be minimized or neutralized at times, making the contract attractive for some interested parties at particular times. However, the opportunity to utilize the contract is more occasional than constant because most of the time the all-inclusive risk chain remains greater than the reduced price risk related to that particular utilization.

In other words, standard contracts often provide a defense against greater risks than what the user needs, making the cost higher than the benefits to the user based on its individualized usage and risk management needs. The benefits from utilization of the contract must be found individually, and the benefits must remain fair under these circumstances, which makes finding an opportunity increasingly difficult. On the other hand, a contract that was just beneficial to a single party would have to be placed and could not typically be traded in a formal centralized exchange auction. Standard contracts face a threat of diminished real usage because of these factors, and a distinct rising of the hidden cost of zero sums resulting from the lack of such usage.

When used herein, the term “supply” refers to the quantity or amount (as of a commodity) in the market; the term “usage” refers to the quantity or amount (as of a commodity) to be used; the term “yield” refers to the production of a commodity; the term “inventory” refers to the quantity or amount (as of a commodity) on hand.

In addition to price being the differential of standard contracts, the nature of the use of price in standard contracts further reinforces its weight. Because traders typically can buy exchange-traded standard contracts on margin, price enjoys a leveraged position in standard contracts. In addition, price has always had a far greater magnitude in the minds of traders than the amount of the contracted commodity, because price relates directly to the ability to access or define opportunity within the standard contract. Still further, because there is no actual need to deliver the actual underlying referenced commodity at the time a standard contract is traded, supply has been relegated to a lesser variable than price because supply is more distant. For these and other reasons, in standard contracts supply is not an element of equal weight to price.

In addition, the need for reliable supply runs very broad and deep in almost all industries, and is especially so in those that utilized standard contracts for accessing it. Supply is always available in some type of marketplace; however, its reliability is not always relevant to all types of usage. The common denominator for usage is pricing power—ranging from a small price differential related to cost or access to a real or potential usage that is fully leveraged to price. Pricing power mandates that supply be managed from its own point of view instead of other forces because it is a whole that is related to just a part. Thus, there is a need for reliable product production that is differentiated by usage that can be addressed by developing a market that is traded based upon an assessment of risk related to that usage.

Further, standard contracts use cost against a margin of profit or some other standard which reduces the marketplace value of the product related to time very quickly. Time-distance is the relationship between supply, price, and time. As time-distance increases between price and supply, price become more random (because there are more unknown factors to take into consideration), and finally at a significantly forward time the relationship is broken and price of a standard contract becomes nominal (quotable, but the contract is no longer usable for risk management). It is not until the end or near the end of a standard contract duration that supply approaches an equal or greater importance to price because the supply is actually going to be used. Thus, the use of cost against a margin of profit generally reduces the usefulness of the standard contract in forward time. While a reliable future supply is desirable, the use of price in standard contracts limits their use in this manner.

At an organic level, however, supply is the key element in any such contract because, without supply, meaningful price activity cannot take place. Supply therefore offers a more direct economic base from which to start, and a need exists to be able to engage this focus. Having supply in the background, as it is in standard contracts, reduces the two-sided balance to that of just price going up and down. It is very difficult to relate to a supply need under such circumstances.

Contracts related to the usage requirements of participants rather than generalized market price, on the other hand, have the potential to be beneficial to each individual participant. Usage provides a basis for the reduction of the zero sum effect related to balanced transactions of the marketplace in that usage transactions are mostly private and therefore left out of the price discovery process of standard contracts. Thus, usage transactions remain individualized. This is because usage requirements are derived closer to the origin or production of a commodity instead of at the more distant and higher echelons of industry-wide delivery standards. Requirements that come from such higher industry-wide standards have little organic attributes.

The combinations and limitations that can take place between standard elements, namely quality, quantity, duration, delivery time and location, price, and related pricing derivatives, provide more flexibility than just price alone if each element is greater or less than an ordinary fixed standard. The price risk chain includes many independent risks: by highlighting the most dominate element in a contract—the amount of crucial (i.e. partialized) supply—and allowing for a small change to potentially leverage this crucial supply, the broad market price risks become subservient to a normally passive supply. A defined economic beginning can be brought through the remaining gauntlet of risk by means of navigation rather than by a direct course. Therefore, contracts that highlight partial supply potentially have a more direct benefit, a more constant use, and more diffusion as it relates to confrontation, and thus would provide benefit to the industry to which the invention relates.

What is thus needed is a contractual basis that provides a better economic basis than the focus in standard prior art contracts on price and its relationship to time. Such contractual basis should relate more directly to undefined usage needs than standard contracts of the prior art. Such contractual basis should bestow upon supply a more influential status than standard contracts of the prior art in both the near term and more distant timeframes. Such a contractual basis also should diminish the dominate adversarial nature of standard contracts of the prior art in that such contractual basis has the potential to be beneficial to each individual participant through his individual usage Such contractual basis should advance pricing power to supply related to standard contracts. Such contractual basis should grant a more influential status to supply than mere price referencing.

### SUMMARY OF THE INVENTION

A contractual basis in accordance with the principles of the present invention provides a better economic basis than the focus in standard prior art contracts on price and its relationship to time. A contractual basis in accordance with the principles of the present invention relates more directly to undefined usage needs than standard contracts of the prior art prior art in both the near term and more distant timeframes. A contractual basis in accordance with the principles of the present invention bestows upon supply a more influential status than standard contracts of the prior art. A contractual basis in accordance with the principles of the present invention diminishes the adversarial nature of standard contracts of the prior art in that such contractual basis has the potential to be beneficial to each individual participant. A contractual basis in accordance with the principles of the present invention advances pricing power to supply related to standard contracts. A contractual basis in accordance with the principles of the present invention grants a more influential status to supply than mere price referencing.

The present invention provides an improved commodity contract that can be traded based upon leveraged supply differentials that provide pricing power in the marketplace to that supply. Instead of focusing primarily on price for the underlying market as a whole, contracts according to the present invention leverage the partial of supply of the underlying referenced whole, creating a mechanism by which entities having an active interest in the underlying referenced commodity can take advantage of the benefits of the contract, while also being beneficial to both the buyer and seller. The partialized supply runs from organic (supply development prior to marketplace entry) to inorganic (where it has already entered and is part of the marketplace). Only a portion of the organic supply to arrive at the market has the ability to be leveraged because time-distance has been eliminated, while the inorganic arrived whole supply is needed for leveraging the costs associated with increased time-distance. Contracts according to the present invention allow either of these supplies to be the dominant focus because of direct engagement to usage.

Once supply has been leveraged in the manner of the invention, supply achieves a greater weight than price because price changes are contained within the leveraged boundaries of supply. Leveraged supply related to price is a condition where price is contained within the leveraged boundaries of a whole to a part i.e. leveraged supply is greater than price change. Leveraging supply serves to greatly increase the one-dimensionality of price making it non-random by absorbing random activity, and reducing the effects of the zero sums associated with standard contracts by reducing the uncertainty normally associated with standard contracts.

Thus, a single known element becomes the dominant focus because the risks related to leveraged supply are greater than the other elements combined. In the prior art, it is a background of undefined uncertainty that inhibits usage.

### DETAILED DESCRIPTION OF THE PREFERRED EMBODIMENTS

While a contractual basis in accordance with the principles of the present invention is primarily described herein with respect to domestic agricultural commodities, the principles of the present invention can be applied to commodities in the broadest sense, such as for example precious metals such as gold; fuels such as petroleum products; foreign currencies such as the Euro; and financial instruments and financial indexes, to name an expected few. Further, the principles of the present invention can be applied to different production contexts such as domestic agricultural production and foreign export production, for example Brazilian soybean exports, Ukrainian wheat exports etc. With respect to contracts on agricultural commodities such as corn, soybeans and wheat, acres-yield and varied differential structures offer a basis for a series of new contracts in accordance with the principles of the present invention.

There is a standard industry need at the grass roots level for a lessening of individualized risk related to usage versus a standard risk related to the whole of the supply in the market as reflected in a single price. The individual risk within the risk of the whole of the market is isolated in accordance with the present invention. This isolation of supply (in part related to a shorter time-distance or in whole related to a longer time-distance) provides the basis for the lessening of individualized risk related to usage because it directly relates to the organic nature of production, and the inorganic nature of inventory. In a purely speculative undertaking using standard contracts, the use of the contract for the whole of the risk does not permit deviation from the zero sum effect. Thus, in standard contracts that risk is easily transferable because no undefined usage attaches to the original contract.

For contracts according to the present invention, the leveraged supply at the outset is greater than the sum of the other risks. While this makes it more likely that the contract will be less transferable as the contract is mostly attached to non-standard usage, this frees the contract from the emphasis on price within standard contracts and reverses the emphasis of a single price definition to a broader, more encompassing set of circumstances that serve to better define opportunity.

A given amount of the commodity, a necessity for the supply emphasis, should be isolated in order to support the needs of the participant, and differential contractual elements should be layered and include an off/on capability outside of cancellation in order to create a broken-up time-distance relationship from which to further cement or extend contracts among participating parties. Any portion of supply that is used needs to have leverage related to potential usage in order to overcome the costs associated with access, instead of just common random price that is available from the liquidity process of the marketplace. Leverage creates a non-random price condition in this format. The supply factor must represent a large enough percentage of the whole supply to maintain a dominant position. Supply and price combined into flexible and separate formats offer an opportunity to control the volatility associated with multiple standards priced into a single standard contract.

As a stand alone beginning, the supply imbalance when it occurs will be relatively small—and will carry the same influence which is that of leveraged change that contract supply should have. The whole of the supply has very little direct influence because usage is not immediate while the partialized supply carries leverage because it reflects change related to this most needed portion. Thus, a contract according to the present invention represents a separation within supply that carries the burden of price discovery. On the balance of the contract, price can be referenced, but does not need to be activated.

Contracts according to the present invention provide an insight to the benefits of supply differentiation and limit the initial stages of risk exposure to this uncertainty before pricing comes into play. The foundation of supply as the obligatory basis of change or differential offers a new and refreshing opportunity because it is a contract that allows a breakdown to both an “organic” element related to developing supply, and an “inorganic” level where supply has already become a part of inventory.

At a partialized level, supply can be guaranteed or can be the basis at risk for additional price management farther downstream. The contractual risk elements can be isolated and evaluated separately, allowing each economic risk to be measured and priced as needed through the life of the contract. In other words, contracts in accordance with the present invention help a user define opportunity at the start rather than hoping for a super yield or a favorable random monetary price differential at the end. Acres can be exact; yield can be specific (for example, to U.S. standards) or more specific (such as to a particular state, county or farm).

For instance, there are cases where the industry has higher yields and therefore lower prices; but an individual farmer who has a low yield still receives the same lower prices. A partial supply guarantee therefore would provide for an improved situation for the individual farmer, and allow a better opportunity to manage price and overall farm related risks. This also allows for good land to be leveraged, while permitting a corresponding transaction to occur for poorer soils, with both types of transactions leveraging supply as it relates to their needs. In such situations, the supply differential is more important than the price differential because the supply differential leverages the usage of the land. Benefits can accrue on both sides of the transaction and to either choice that could have been made at the outset.

Supply—the number of acres multiplied by the yield for the location—conveys a practical difference to conventional standard contracts. The yield standard combined with acres provides an unusually sound basis to anchor a contract for many reasons. For example, supply focuses on first things first, allowing earned benefits to follow. Supply allows unique ways to transfer ownership without the immediate complications of dealing with price, and supply can be adequately projected on a non-nominal basis from the present to future years.

The window for affecting yield is a very small, well-defined time frame. Conditions such as planting dates, rainfall, heat degree-days, seed improvements, chemicals and fertilizers, and measuring devices such as satellite imaging, global position satellite (GPS), etc. are focused technologies that help ensure accurate development of yield output. Acknowledged trend yields are testimonies to the one-dimensional nature of this output, which lends strong support to any need for a projected basis. Of itself, trend yield is a partialized supply and leverages productivity related to input costs.

This small window for affecting yield sits in sharp contrast to the uncertainty that price exerts over the life of contract duration. As price becomes more distant from the present, it rapidly moves to a nominal basis that inhibits trade. Use of cumulative yields (for example 2002 through 2007 yields—40 bu. +40 bu. +40 bu. +40 bu. +40 bu. equals 200 bu.) offers a reliable output with a time dimension that overcomes what would normally be a nominal discovery basis. This distance can be bridged again through mediums that move both forward and back through time, such as interest rates, storage costs and other partialized costs.

The benefits to be achieved through the present invention are derived from carrying a long or short leveraged supply over time. The first obligations in contracts according to the present invention are related to yield and acres. These contracts can vary from buying or selling a fixed supply to contracts where more variability is in place. These contracts can have guarantees that open the field to financial premiums and therefore a commitment to cover the yield of a commodity against underproduction of that commodity or for its future delivery. This is accomplished pursuant to the present invention through providing replacement commodity as a result of partializing supply. Differentials are expressed in some gauge of quantity (such as bushels), and the choice in other contractual elements is individually based and likely third party enacted.

The pricing structures for the parties are open and not a direct part of the supply obligation. Individual valuations can be accomplished with a variety of neutral third parties having no interest in original contractual obligations, using the time allotment within the contract.

A matrix of the present invention allows price activity to be internally controlled through a broad range of time (such as five years, for example), a choice of instruments plus standard derivatives, manageable segments of time similar to contract months, and an on/off capability (for price only).

Pricing remains an open opportunity that is very similar to a placement because of the ease of creating opportunity and the ability to enable it. This is in contrast to the found nature of opportunity in standard contracts. The difficulty of requiring a single price for both producers and purchasers has lead to the degradation of production process in the marketplace. Farmers or other closely related businesses are closer and have a much better understanding of likely events that affect this initial stage of partialized output. This opens a large opportunity for the agriculture industry to reverse and internally retain the cash flows related to services that have always flowed out and away from them.

The base for the contracts of the present invention is leveraged supply, and the physical and time location of that supply. Supply management within the range of time and location provides a much sounder forum from which to manage than just price, and allows a much broader platform of participants and contractual elements. Structurally in the new invention, supply as a given whole is moved forward and reduced to a crucial component, which fundamentally alters the normal time-distance relationship by keeping price engaged to supply. This new whole is further fractionalized so that a partilized parameter (or parameters) becomes the numerator while the denominator remains the new-forwarded basis of supply. This creates the needed leveraged position of a part to the whole.

The risk chain related to the whole of supply also is changed by moving forward to a more all-encompassing singular risk element. This then gives one-dimensionality to those change parameters as others cannot be measured—they are shut out due to being less than the assigned risk. Where usage is not a consideration in standard contracts, zero sums prevail. Supply that carries with it pricing power is not a whole-to-whole relationship, which allows it to reduce the zero sums effect that has always been associated with the pricing function of markets. In addition, the reduced uncertainty of zero sum allows fees or premiums to be assessed prior to production.

This new forward focus offers a related usage fee or premium for access that can be assessed prior to organic development rather than price discovery that is after the fact or a forward projection. The new relationships in accordance with the principles of the present invention can offer a more limited exposure of inventory to the zero sum effect by offering a partialized supply that would be at risk in the price discovery phase while the greater supply related to usage was free of and could take advantage of the price discovery in the zero sum. This partialized supply acts as a numerator to a single price risk relationship that is zero sum, but the denominator remains independent of that and leveraged to the numerator and to the discovered price related to the numerator. Producers and consumers, whom have usage needs of an opposite nature, have a small zero sum effect on the partialized portion at risk (the numerator) while are free of the zeros sums related to the denominator, which is a much larger whole. Leverage arrives from this ratio and from usage as expressed in volume of the contract used by the participant related to their individual usage.

Farm output has led the economy in understanding the benefits of productivity. Productivity has increased production and lowered prices—not unlike what has taken place in the economy during the last decade. The effect of productivity is to erode pricing power to the direct benefit of the consumer, as the supply increases more rapidly than the corresponding usage. This creates a bottleneck of oversupply that time does not allow the market to absorb because productivity has tended to remain as an ongoing process. In addition, the carryover of this oversupply ties up resources such as capital, and other costs related to this excessive inventory. Profitability depends on momentary monetary price differentials related to production efficiencies or market inefficiencies. In agriculture, a better focus than hoping for higher prices or the hedging of pure price risk would be to deal with the effect of higher production more efficiently by allowing inventory to assume a more productive role. Inventories need to be incorporated within a usage concept that offers direct benefits rather than just inventory carrying charges that have to be overcome.

Cost of production in this context cannot equal gross per acre. In fact, cost of production will be higher because efficiencies have to be implemented industry wide in order for a chance to survive. Trying for super yields is risky because it increases both fixed and variable costs and potentially lowers the final price per unit over time. An industry approach such as this has produced a small, yet consistent erosion to the value of production over the years and any reasonable set of assumptions will extend it further into the future.

The price with which markets deal is a retail price related only to the whole of production, which again makes it very difficult to use. For example, assuming around seventy percent (70%) of marketplace production has costs below this retail price, while around twenty percent (20%) of marketplace has production costs above the retail price (the ten percent (10%) remainder of the marketplace production is about break-even). The present invention further partializes the market into two new categories: “Price-minus” or where the unit costs are below retail price, and “price-plus” where supply in a favorable position is worth more than the retail price. These new categories both give a more realistic foundation that could support the industry by changing the whole into more workable parts.

For example, an index made up of both fixed, variable, and soft costs can be constructed in accordance with the present invention to allow a more and greater transferability through the listing of these cost items. This is because in usage terms, these cost items cannot be identical and offer substitution, or partial or whole elimination of costs related to eventual ownership of inventory. Pricing power is related to a leveraged position, and pricing power can not be overcome by other contractual elements because of the lack of time-distance between supply and price i.e. keeping supply engaged.

Time-distance is the relationship between supply, price, and time. In standard contracts, as time-distance increases between price and supply, price become more random, and finally if it breaks the relationship, price becomes nominal (quotable but not useable). The index of the present invention is a whole and can be projected forward at for example an increased or decreased percentage of production costs without significantly offsetting the value of the supply. In comparison, price discounting reduces the whole to a small portion related to margins that becomes nominal. Partialized supply reduces the time for market reaction by engaging it to price, while in standard contracts supply comes into play later, and in distinctly forward trading, the whole of the supply is moved forward in time without costs normally associated with time.

Yield, which is used today as the only avenue available to overcome the insurmountable economic odds facing production, needs to find a new and a more reliable role. “Price-Minus” means you have to get a unit cost below market price to increase transferability. Instead of using the whole supply, only a partial supply (for example, the 70% of low cost production) is used. The difference between the cost index and the market price should be reliable and sustainable over time. If the difference is reliable, the market is broadened because it allows sales into a broader range of partial price structures that are relevant to production.

For the cost index, it is important to reflect the costs of getting supply into a usable position as well as the more direct costs related to production. It must be detailed in the various cost categories because each category can diffuse the need for a greater overall risk than comes from unknowns. What is needed is to define each area of risk individually, which allows for the partialization of the risk. Thereafter, this partialized risk can be traded in a sense. For instance, energy costs can be stated as thirty dollars per acre ($30/acre), but this can be broken down as twenty dollars ($20) for diesel fuel, and ten dollars ($10) for natural gas. For some producers the costs will be too high or too low, and the same for other categories. For instance, a corn producer in the more southern part of the productive Corn Belt who does not need to dry his corn will save the cost related to natural gas; a corn producer near the place of usage will save the cost of transportation of his inventory, etc. The summation of the individual assessment of element basis related to both costs and pricing helps to insure usage as far more individuals can participate. In other words, the index is a basis rather than a fixed standard. It is important for the cost index to create a differential representation between the selected supply and price. Other elements can offer more or less as a means of internal differentiation for broadening the contractual basis. This process also serves an internal means to upgrade the mix so that the index remains relevant.

What normally would be a two party transaction—the buyer and a seller with a single price differential—can now be a transaction that can entertain far more participants with varied interest related to usage and outcomes. The normal farmer-banker relationship of financial haircuts (less supply-less than market price) on the banker's side is dissipated—the soft cost on part of the farmer that have been the real safety margins in the transaction can be more efficiently introduced by third parties, and serve to transform the marketplace into a more modern and useful place to transact business.

The market price needs to be above the base threshold of production (for example, the 70% of low cost production) just as it was in the above example, and remain above the lowered cost index, for the majority of its existence. The holder of inventory is now like a low cost producer whom the market protects. Usage can expand under these conditions because of the pricing power now in force related to inventory supply, and from an economic standpoint it reverses the negative grasp that productivity has had for so long.

The experience from carryover of supply has shown that supply carryover has an influence over price in overproportion to the quantity of that supply. This is a natural leverage phenomenon in the market. Under standard contracts in which price is the focus, this natural leverage creates an unduly large and therefor negative influence on the price. The present invention reverses the effect of this natural phenomenon to create a positive influence by utilizing leveraged supply in an opposite way. Under the present invention, the market only needs to deal with a small part of inventory to raise the whole structure of price. As in ordinary markets, usage increases when understandable risks are negated. The invention helps alleviate supply bottlenecks and the carrying costs of oversupply through the extension of partizilation into more and more territories, rather letting the whole collapse the industry. Inventory needs to act again as a buffer to over-under supply to help regulate usage.

The economic reliability of yield out forward has no known peer in the price world. Nominal markets are always associated with forward time, as normal price discounting extracts too large a premium for that access. (Note that discounting is one-sided—representing only the present at some fixed cost.) Taking the present forward requires a whole and not a partilization. It needs to be relatively free from externally assigned costs and instead related to production costs. It expands usage by providing a structural matrix or platform that diffuses price into what can be called price opportunities. Defining the risk-price relationship to supply is much easier under these conditions because there are far fewer unknowns that normally raise the risk profile.

Types of contracts in accordance with the present invention may vary from the more straightforward to contracts that are more customized. The desired coverage for contracts arises from the enabled pricing power that supply now has with price and the various time dimensions and locations now available. Very little usage should fall through the cracks in this atmosphere. Independent third parties relate to the field of risk by allowing its diffusion to be commonplace. Types of transactions, the zones for activation, pricing, duration, location, etc. serve individual needs.

In standard contracts, the differential is based on price. Thus, the only variable is whether the price is greater or less than the referenced price. The market price hovers around production cost, giving only brief moments from which to use it. A matrix according to the invention includes the elements that comprise risks that affect supply, such as for example time of production, weather (for agricultural commodities), energy costs, fertilizer costs (for agricultural production), location of the inventory, etc. The pricing is layered to provide economic platforms related to the differing relationship between production and market value. An example matrix in accordance with the principles of the present invention is set forth in Table 1, below:

TABLE 1
Contractual Elements

| | |
|---|---|
| Time | > > > > > > >0< < < < < < < |
| Soft costs | > > > > > > >0< < < < < < < |
| Energy Cost | > > > > > > >0< < < < < < < |
| Fertilizer Cost | > > > > > > >0< < < < < < < |
| Location | > > > > > > >0< < < < < < < |
| Interest rates | > > > > > > >0< < < < < < < |
| Storage rates | > > > > > > >0< < < < < < < |

Where the horizontal axis reflects the degree of greater than (>) and/or less than (<) the last referenced price, and the vertical axis represents the various risk or cost elements for the partialized supply. The vertical zero column in the center of the graphic represents a standard from which movement can occur to complete a transaction. Acceptance, substitution, elimination, arbitrage, are part of means to accomplish transactions.

### First Embodiment

A first product according to the principles of the present invention is a contract to cover the supply of a commodity against underproduction of that commodity by providing replacement commodity so that production can be a reliable factor. The market will establish premiums for the various bushel risks. This program can be far more competitive and efficient than what is currently implemented. This first product in accordance with the principles of the present invention is a rather straightforward program that can be well understood by those in the art, thereby offering a broader and more inclusive base for participation than any product now traded.

Other less visible or understood markets can be created to serve the industry further. Contracts designed for usage will bring new people as well as capital. Change is needed from the single pricing mediums that serve only the fringe of needs to ones that offer more flexibility and that can be tailored individually.

Examples of some of the types of trades or reached accommodations or agreements that can occur between parties are as follows: a farmer, who one might assume would want to sell inventory, may be better off being a buyer. He needs the extra supply to reduce his cost per bushel just as he always has. He has two ways to accomplish this with the invention—one is to buy the yield to insure a lower per bushel cost, and the other is to sell it for the premium that directly reduces his overall cost per acre by the amount of the premium received. Both represent a favorable choice, but one is likely to be more suited to his individual needs.

The banker, by loaning to the farmer, can require the farmer to insure his yield or reduce his cost by taking the premium offered. The banker also will have a loan portfolio of production loans of differing risks, but fundamentally related to production more than price. The banker can net the overall risk of the portfolio by buying a yield basis on a portion of the loans, thus leveraging a partial shortage of production to the whole of the production expected; or the banker could use a guaranteed supply to sell a price basis, if one is favorable on a large but not total portion of the expected production. The latter, accompanied with some producer adjustments, can move the banker's portfolio into the financial instrument world of time defined instruments with cash returns.

Yield, location, time, and price elements, rather than just standard commodity price, and independent assessments of third parties will come together in accordance with the present invention, providing a foundation for enablement. A much broader based market will be the result because of the introduction of a larger participant base with diversified interests that create a larger capital pool. The foundation for discovery is balanced for both sides, as seen in the fact that role reversal is fundamental to fairness, and remains the basis for variable discovery within the principles of the invention. In other words, the trading parties have a choice of beneficial trades that are not forcing or adversarial within their usage base. Instead of the conventional situation, a trader could either buy or sell a contract according to the present invention and still arrive in a beneficial situation without the opposite trader entering a worse situation.

In accordance with the principles of the present invention, a contract or a series of contracts based on the partial supply of the commodity rather than the price of the commodity are provided. It is anticipated that contracts based on the partial supply of the commodity rather than the price of the commodity in accordance with the principles of the present invention will take on a variety of forms and formats as dictated by the broadened marketplace. In addition, it is anticipated that the purchase and sale of contracts based on the partial supply of the commodity rather than the price of the commodity in accordance with the principles of the present invention will take through a variety of means as dictated by the marketplace.

Set forth below are examples of contracts based on the partial supply of the commodity rather than the price of the commodity in accordance with the principles of the present invention. While various particulars are used in the following examples, such as a single price, in order to portray the principles of the present invention, the present invention is not limited to such. Thus, the following are non-limiting illustrative examples of financial products in accordance with the principles of the present invention.

### EXAMPLE 1

### Equal Land—Low Yield

A type of contract which could be bought and sold according to the principles of the present invention relates to providing supply protection to farmers on crop yields. For example, assume that contracts are being arranged for soybeans grown in Illinois in 2002, where the forecasted average yield for soybeans is forty-five (45) bushels per acre and the expected price per bushel is $5.00. The farmers expected gross revenue is thus $225 per acre. Assume, for example, that the farmer's gross cost for growing soybeans is about $165 per acre. The farmer's expected profit is thus $60 per acre ($225-$165).

It would be advantageous for a farmer to be able to hedge his or her exposure to the various risks affecting yield that farmers face when planting their spring crop, such as planting dates, rainfall, heat degree-days, etc. Under the present invention, individual farmers could buy and sell commitments to cover differing supply differentials.

A contract according to the principles of the present invention enables the farmer to buy a commitment to cover the supply of a commodity against underproduction of that commodity that would pay out in the event that that a regional yield per acre, such as the yield per acre of the state of Illinois (or some other source having sufficient pricing power), fell below the forecasted average yield for soybeans. The farmer could purchase such a commitment to cover the supply of a commodity in accordance with a differential matrix that sets forth increments of yield shortfalls and the price per acre at which the farmer could pay for the financial protection to farmers on crop supply shortfalls. A sample differential matrix is as follows:

TABLE 2
Soybeans

| Differential (bushels) | Price per acre |
|---|---|
| 45-40 | $15 |
| 40-35 | $10 |
| 35-30 | $5 |
| 30-25 | $3 |

Thus, in order to financially protect against a crop yield falling from 0 to 5 bushels per acre short of the forecasted state average yield for soybeans, a farmer could purchase a commitment to cover the supply of soybeans that would pay out in the event of such shortfall. After paying out $15 for an acre, if the state yields 40 bushels of soybeans per acre, the shortfall is 5 bushels, and the buyer would receive the 5 bushels an acre from the seller.

Alternatively, in order to obtain immediate funds the same farmer could sell a commitment to cover the same supply of soybeans. After receiving $15 for an acre, if the state yields 40 bushels of soybeans per acre, the shortfall is 5 bushels, and the seller would payout the 5 bushels an acre to the buyer.

It would be logical for the farmer to sell a commitment to cover a 45-40 differential or a replacement inventory for lost state production at the $15.00 rate. At the expected yield of 45 bushels per acre, the farmer's cost per acre is $3.67; the gain per acre for the 5 bushel differential between 40-45 is $3.00 per bushel. Thus, a contract in accordance with the present invention would allow this farmer to directly offset his gross expense by $15 per acre (now $150). If the state yield fell by the five-bushel amount, he could offset with part of his production (which potentially could still be above the historical state average), and recover the loss through an increase retail price on the remaining portion of that production through the crucial supply that was leveraged to the state yield.

Because the reduced Illinois yield decreases the supply in the market and thus increases price, assume the price per bushel of soybeans at this lower yield per acre is $6.00. The reason for the increase price on his base production is because the volume of soybeans produced in Illinois represents a significant portion of production. The actual yield of 40 bushels per acre instead of 45 is the small change related to a critical supply in accordance with the invention. This concept is confirmed in that prices did increase over one dollar in 2002 in spite of Iowa (a state with a similar production impact) producing several bushels more per acre.

If our farmer for a one-acre plot of land with the same production as within the state sells at the $6 per bushel price, he regains $40.00 because of the higher price ($40.00=(40 bushels)($1.00 price increase)). The farmer selling the commitment to cover the supply of soybeans would receive a payment of $15.00 and have a cost from the five bushels of a value (calculated as if he purchases the 5 bushels at the $6 per bushel price) of $30.00 ($30.00 (5 bushel payout)($6.00 per bushel)), and the $40.00 from the increase in the retail price for a net increase of $25.00 per acre ($40+$15-$30). If the farmer buying the commitment to cover the supply of soybeans sells at the $6 per bushel price, he would receive revenue from the five bushels of $30.00 ($30.00=(5 bushel pay in)($6.00 per bushel)), less the premium paid of $15.00, and the $40.00 from the increase in the retail price for a net increase of $55 per acre ($30-$15+$40).

Put differently, with the actual yield of 40 bushels, either farmer's revenues would have been $240 ($240.00=(40 bushel yield)($6.00 per bushel) offset by a $165 gross cost for growing soybeans for a profit of $75 per acre. The farmer selling the commitment to cover the supply of soybeans would net a profit of $60 per acre ($75+$15-$30) while the farmer buying the commitment to cover the supply of soybeans would net a profit of $90 per acre ($75-$15+$30). Both returns are greater than or equal to the farmer's expected profit of $60 on this one-acre plot. Whatever the degree of price response (one, two, three or four dollars) to the shortfall that the market gives, the price response cannot overtake the advantage of supply that the farmer now has. Thus, the present invention protects, rather than being a pure speculative venture for outsized gains. In most cases the opportunity of the invention is and remains greater than its cost as shown in the above example.

### EXAMPLE 2

### Unequal Land—Low Yield

Now assume two farmers having different quality of land. Farmer A's land is premium, such that she expects a yield 5 bushel per acre above the Illinois average yield; Farmer B's land is lacking, such that he expects a yield 5 bushel per acre below the Illinois average yield. Farmer A's expected gross revenue is $250 per acre (50 bushel per acre)($5.00 per bushel) and Farmer A's expected profit is thus $85 per acre ($250-$165). Farmer B's expected gross revenue is $200 per acre (40 bushel per acre)($5.00 per bushel) and Farmer B's expected profit is thus $35 per acre ($200-$165).

Farmer A sells a commitment to cover the supply of soybeans that would pay out in the event of such shortfall, receiving $15 per acre. Thus, a contract in accordance with the present invention would allow Farmer A to directly offset his gross expense by $15 per acre (now $150). Farmer B purchases a commitment to cover the supply of soybeans that would pay out in the event of shortfall, paying out $15 per acre. Once again, at his expected yield of 40 bushels per acre, Farmer B's cost per acre is $4.125; the cost per acre for the 5 bushel differential between 40-45 is $3.00 per bushel, which is less than Farmer B's ordinary cost. Thus, a contract in accordance with the present invention would allow Farmer B to contract for replacement soybeans at a cost $1.125 per bushell less than his cost of production.

Assume the average yield in Illinois is 5 bushels per acre below the expected 45 bushels per acre, and that both Farmer A and Farmer B have a concomitant 5 bushel per acre decrease. Again, assume the price per bushel of soybeans at this lower Illinois average yield per acre is $6.00.

Farmer A regains $45.00 because of the higher price ($45.00=(45 bushels)($1.00 price increase)) while Farmer B regains $35.00 because of the higher price ($35.00=(35 bushels)($1.00 price increase)). Farmer A received a payment of $15.00 and had a cost from the five bushels of $30.00 ($30.00=(5 bushel payout)($6.00 per bushel)), and with the $45.00 from the increase in the retail price has a net increase of $30.00 per acre ($45+$15-$30). Farmer B receives revenue from the five bushels of $30.00 ($30.00=(5 bushel pay in)($6.00 per bushel)), less the premium paid of $15.00, and with the $35.00 from the increase in the retail price has a net increase of $50 per acre ($30-$15+$35).

Put differently, in the absence of a contract Farmer A's revenues would have been $240 ($240.00=(40 bushel yield)($6.00 per bushel) offset by the $165 gross cost for growing soybeans for a profit of $75 per acre. Farmer B's revenues would have been $180 ($180.00=(30 bushel yield)($6.00 per bushel) offset by the $165 gross cost for growing soybeans for a profit of $15 per acre. With the contracts in place, Farmer A's profit would be $60 per acre ($75+$15-$30). Farmer B's profit would be $30 ($15-$15+$30).

### EXAMPLE 3

### Unequal Land—High Yield

Now assume the average yield in Illinois is 5 bushel per acre above the expected 45 bushels per acre, and that both Farmer A and Farmer B have a concomitant 5 bushel per acre increase. The price per bushel of soybeans at this higher Illinois average yield per acre is $4.00. In the absence of a contract Farmer A's revenues would have been $220 ($220.00=(55 bushel yield)($4.00 per bushel) offset by the $165 gross cost for growing soybeans for a profit of $55 per acre. Farmer B's revenues would have been $180 ($180.00=(45 bushel yield)($4.00 per bushel) offset by the $165 gross cost for growing soybeans for a profit of $15 per acre. With the contracts in place, Farmer A's profit would be $70 per acre ($55+$15) while Farmer B's profit would be $0 per acre ($15-$15).

The importance of relating pricing power to a small change in a crucial supply can be illustrated with the following additional example. Farmer A expects a yield of 45 bushels per acre on his farm, but Farmer B is concerned about having a yield of below 40 bushels per acre, due for example to differences in the conditions of the farmer's land. Farmer A can “sell” a 45-40 differential to Farmer B for a given harvest, but the price differential impact will not be present in that Farmer B's production shortfall is not a large enough basis to assume that that the pricing function could happen. Farmer A and B can work together, but they would have to extend the time-distance relationship to perhaps ten years or more.

Such contracts according to the present invention also permit a farmer to hedge on his future sales. Given a price opportunity that is favorable to the farmer prior to complete production development, the risk in that situation is related to the differential between the hedged supply and the actual supply produced. The farmer could use the state production rather than his own production because it is an acceptable standard for both parties. It is important to note it is the state production that offers the needed safety and leverage to the farmer versus the whole of his own production. A ratio of the sale to the amount of purchased guarantee will work just as well in this instance as in the production format. The issue is supply and not supply and price related to a deficiency in production that has to be made up, and, as previously described, in the invention pricing can not overcome the supply advantage gained by it use.

As discussed herein, farmers have the opportunity to be both buyers and sellers of the supply contract, instead of conventional contracts where the tendency will be for farmers to be sellers and depend upon a favorable price. It also is possible that the farmer will be both a buyer and seller of the above contracts at the same time using the different level of supply differentiation matrix. The relationship between soybeans and corn—where again both Illinois and Iowa are crucial supply states—offers a multitude of varying opportunities. The weather focus at key parts of the growing season is roughly the same for both; however, soybeans offer more resistance to drought than corn. In accordance with a preferred embodiment of the invention, the differential matrix is standardized to be close to $25 for the initial strike (5 bushel soybeans)($5.00 per bushel); (10 bushels corn)($2.50 per bushel); (8 bushels wheat (Kansas winter or Montana spring))($3.00 per bushel).

The speculator has been more or less the backbone of most standard contracts. Speculators represent the courage that takes on the zero sum effect of standard contracts that over time keeps opportunity at less than the cost of entry. In the present invention, the speculator needs to operate with less reckless abandon in that pricing power once in place precludes any favorable exit opportunity if exit possibility exits at all. Usage must be brought into play so that the zero sum related to singularity is negated elsewhere. Where pricing power is favorable, the gains will be large and sustainable because the supply advantage cannot be overcome by price. For instance, in a price-to-price strike option with a fixed supply as traded today, it is easy for the market to overcome the gain in the strike with pricing differential changes. A $5.50 soybean call at the planting date price of $4.50 would cost approximately $0.20-$0.25, and after the market rallied a dollar and a quarter to $5.75, the daily pricing differentials of 5-10 cents greatly affect the in the money premium and even more so considering the paid premium.

For the invention's supply strike (40-45) giving five bushels to the owner for $15 per acre or $3.00 per bushel during the identical time period, the results of winning are greatly different. In 2002, for example, Illinois had a five bushel reduction giving the long those beans at $3.00 a bushel. Price fluctuations do not make the trade unprofitable because the supply imbalance opportunity is greater than the cost, and the simple comparison between the two clearly shows a leverage response that is always needed to overcome costs associated with random access. Like the farmer pre-hedging—a whole-to-whole never offers a chance to overcome associated costs related to the transaction. Whole-to-whole is equality between the elements to a transaction—one devoid of a net leverage—like price-to price trading. In the standard option example, the two wholes were leveraged equals and not a needed true or structured leverage, a condition where randomness always prevails (only quicker where margin is expressly present). If wrong, the speculator cannot use price to exit or as a hedge to recover because it will not be there or if it is it will insufficient forum with which to manage. The speculator needs to change from the whole-to-whole format where price prevails to a leveraged usage that is based along the lines of an asset allocation program. This can serve to anchor trades in that the result is going to be a non-random one that offers many satellite-type trades.

The standardization of outcomes, the supply matrix, and the contractual element matrix will offer a new and exciting means to define and plan opportunities versus finding and having little or no time which to implemented them, and this alone will move the speculator to a higher platform of structured leverage from which he has a much better chance of succeeding.

Those that consume or move the product to consumers can utilize that same leverage to their advantage. Manufacturers, importers, or exporters have the same need of supply assurance. Their use is related to their total usage where a small partilized supply can give leverage to their larger needs. It moves along the line of asset allocation where a high risk or defensive posture becomes prudent to the whole of the portfolio. As a purchaser, and where the yield is above the 45-bushel strike, it allows price-time-distance to work to his advantage in accumulating inventory as required by usage, where the yield falls, the favorable leverage acquired allows a blending of purchasing results, which is already practiced in the use of standard grade (quality) classifications.

In the above examples, the matrices according to the principles of the present invention can be varied in several ways in order to fit the needs of a particular market or market segment. For example, the volume differential can be increased or decreased. The time frame during which the supply would be “paid out” also could vary. Additionally, the contracts of the present invention also could be limited to particular markets or sub-markets, such as corn production in a market-making state such as Illinois or Iowa, or to wheat in Kansas or Montana., or to export in Brazil or the Ukraine Any form of crucial supply—whether organic or inorganic—can be leveraged in the invention giving the supply power over price—i.e. making the latter non-random versus its normal random state.

### EXAMPLE 4

### Inventory Investor

The cost index of the present invention relates to further structuring of opportunity by means of transferability, substitution, and degrees (greater than-less than) related to contractual elements, and expanded time-distance relationships. Assume that there is a burdensome supply of soybeans, and that the cost of production (cost index) of the cheapest seventy percent (70%) is $5.00 a bushel, and that with the burdensome supply the retail price also is $5.00. Further assume that without the burdensome supply the retail price would be $5.50.

A pension fund that has cash is looking for a five-year placement of that capital, and can get 3.5% on five-year government note of that duration. There is total safety of principal with the government note, and relative safety through time as expressed by market conditions (surplus supply) and the “cost index”. If instead, the capital is used to buy some of the surplus soybeans at $5.00 per bushel, the fund has a substitutive advantage to the loss of potential income not occurring if some of the cost index related to interest of the stored principal—say $0.05 a bushel—would represent a gain that would accrue due to replacement of capital.

As time moves forward, there will be storage costs, the loss of potential earned income from the cash, etc., and there are time-distance swaps available within the matrix that could reduce these in a direct manner; however, what is more important is that the purchased supply can produce income from the “yield product” by booking the yield premiums that only supply or production can guarantee. At $15 per acre per a five-bushel guarantee, the inert (inorganic) production used gets $3.00 a bushel, and using leverage to the whole—risking only a portion—at one risked bushel for every twenty owned, it would produce at a rate of $0.15 per bushel owned or an annualized return of 3% (five dollar basis) without any price appreciation. Given a loss of the risked bushels to production problems in the State of Illinois (state yield down by five bushels) during the fourth year of ownership, and a resulting price appreciation of $1.00 in the retail market price, the entire production purchased could be sold for gains.

In this example, the carryover production within the field of the invention has been packaged much like a convertible bond, where some lesser income is produced (choice for more is related to the ratio of product used) with the potential for exercise (indirect) and larger than anticipated gains. Going back to the original fund purchase, a rate of one-half percentage point less than the market offered with safety of principle is an advantage by itself because it lets inventory participate in new developments. The natural role for inventory is to serve as a buffer at market extremes, and this invention reduces the effect of burdensome supplies with no time-distance, to where time-distance can be afforded. Not much of the burdensome supply that pushes to reduce time-distance and consequently retail prices has to be removed in order for the whole of the market to respond. This again is partialized leverage, and is the use of a negative in a positive way that allows the marketplace the freedom to perform. Clearance is the way to renewed pricing power of the whole.

### Second Embodiment

A second product according to the principles of the present invention is a supply time-distance relationship that allows space to occur between supply and price. Current production can be placed forward and/or future production can be brought current in accordance with the needs of producers, users, etc., and the needs of the marketplace. This exchange can be far more competitive and efficient than what is currently implemented because of the added mix of reduced costs and increased income (made possible by time-distance separation) from what are now treated as negative leverage events due to a lack of time to deal with them and their associated costs. The ability to move production in accordance with the needs of producers, users, etc of this second embodiment in conjunction with use of the contracts of the first embodiment to hedge their respective contract positions offer an valuable service to the industry.

A simple example would be one of a transfer of a present inventory to the future. Two farmers who both farm a thousand acres of soybeans and have production of 40,000 bushels can swap the present for the future. One takes the others supply, and gives in return his production for the following year. The farmer who would have to pay storage and give up any potential income related to a cash sale, can avoid the direct costs and receive some income from the recipient of transfer. The recipient farmer has used the money to pay off an equipment loan or lease that had an imputed rate of 9%. The effective price of soybeans has been raised due to this broadened opportunity, and the transferring farmer can receive a small part of this as well. Now, storage has been eliminated, some income has been produced, and the farmer who took the forward production can sell at any time.

Another more complicated use would be to use cumulative yield as the basic structure for buying additional farmland. A young farmer who farms a thousand acres as a tenant, and has the opportunity to buy five hundred acres for $2000 per acre, can now bring his future production to the present or use it in a sinking fund way. The land is in Illinois and has generally produced at the state average of 45 bushels per acre. He would like to sell the cumulate output from the land for the next ten years for an up-front cash loan. He offers a guaranteed annual yield of 40 bushels per acre or twenty thousand bushels a year or two hundred thousand bushels over the ten-year time frame, and offers to give the buyer an additional bonus of the first bushel over 45 on any given year, but keeping any other increase. Again assume a $5.00 per bushel cost index and a market price just slightly over that number. The interest cost portion of this cost is $0.50 and since the money is going to be up front the buyer offers to pay 105% of the cost basis (index) for the ten year price, and wants an offset due to the up front capital of $0.40 per bushel because he has replaced some of the capital costs.

The young farmer is saving direct interest costs on mortgage basis, so he agrees to the pricing structure—$5.25 less the $0.40 or $4.80 a bushel, and a total up front loan amount of $960,000. He gives the purchaser a security interest such as the first mortgage on the land to secure the deal. The buyer has increased the distance between his cost and the market retail price, and now has a supply with which to manage. He can act the same as the farmers in the earlier examples to enhance his income; the young farmer can use the second strike option (40-35) to insure his production or use some of the rented land production as a buffer, and decide to take some premiums. What has transpired is an increase in activity that makes more positive outcomes possible versus stagnation and little if any opportunity.

The cumulative note supply offers pricing opportunities throughout the time duration established in the matrix. The buyer needs pricing power and time is an ally for him, since at some point in time favorable pricing will occur. The buyer needs safety related to production and the seller can include or offer an insured output.

The seller needs dollars up front to help complete the land purchase. He doesn't want to give it away so he needs to retain some pricing power, and the need is for these two parties not to remain totally opposite—the structure needs others not related to the immediate transaction. Supply can be moved forward to the present by swapping more current supply from someone else. A swap of just production opens opportunities to defer income and pricing for others, and with the insured production of this transaction, the deal can be easily structured. It is cheaper than interest and storage (cost of carry) for someone wanting to price in the future. That person is already forgoing an interest rate or investment return on the captive capital in hopes of something greater internally from the market. Many alternative types of structured products can be achieved through the matrix.

### Additional Embodiments

All the good things that can happen within an industry start with the level of money available to use. Whether it is new technology, or a natural resource, etc., it is fundamental to have the related opportunities greater than the associated cost of entry. Financial instruments that have attached earnings, offer flexible management, and have solid security are probably one of the closest to these needs, and therefore offer a means for attracting capital at the broadest of possible levels.

In our banker example a portfolio of varying loans across a time spectrum was structured to the needs of direct production. The same can be done to service the financial industry, which needs the upside potential available rather than deterioration associated within a fixed environment. It is the desire for security of principal that leads to such limiting circumstances—passive demand instead of active. Not only can this field grow, but also the financial services field that is suffering with old and tired mediums. New standards that are flexible and active that come from an environment infused with some organic development are the coming wave, and the invention with its all-encompassing grasp of these new fundamentals will lead the way.

As is the case with the contracts described in accordance with the first embodiment, contracts of the type described above can be particularly crafted to meet particular needs. Items which could be customized include the crop or commodity, the market or sub-market, and the delivery periods. Furthermore, it also is possible that exchanges of different commodities, and even different types of commodities, could be completed according to the principles of the present invention. For example, it is possible for Farmer A and Farmer B to exchange a present production of corn for a future production of soybeans or vice versa.

While the invention has been described with specific embodiments, other alternatives, modifications and variations will be apparent to those skilled in the art. For example, while described herein as applicable to various commodities the principles of the present invention can be applied to other products such as for example stocks in which supply can be leveraged. Accordingly, it is intended to include all such alternatives, modifications and variations set forth within the spirit and scope of the appended claims.

What is claimed is:

1. A financial product comprising:
a contract having supply as a variable with greater influence than price.

2. The financial product of claim 1 wherein the contract is on a commodity.

3. The financial product of claim 2 wherein the commodity is an agricultural commodity.

4. The financial product of claim 3 wherein the agricultural commodity is corn.

5. The financial product of claim 3 wherein the agricultural commodity is soybeans.

6. The financial product of claim 2 wherein the commodity is metal.

7. The financial product of claim 6 wherein the metal is gold.

8. The financial product of claim 2 wherein the commodity is a fuel.

9. The financial product of claim 8 wherein the fuel is a petroleum prodcut.

10. The financial product of claim 2 wherein the commodity is a currency.

11. The financial product of claim 10 wherein the currency is a Euro.

12. The financial product of claim 2 wherein the commodity is a financial instrument.

13. The financial product of claim 2 wherein the commodity is a financial index.

14. The financial product of claim 1 wherein the contract is a commitment to cover the yield against underproduction of that yield.

15. The financial product of claim 14 wherein the contract is a commitment to cover the acres yield of an agricultural commodity.

16. The financial product of claim 14 wherein the commitment to cover the yield comprises a differential matrix of ranges of acres yield of an agricultural commodity.

17. The financial product of claim 16 wherein the differential matrix sets forth increments of yield shortfalls and the price per acre that the financial protection on crop yield shortfalls costs.

18. The financial product of claim 14 wherein the commitment to cover the yield is swapped between producers.

19. The financial product of claim 14 wherein the commitment to cover the yield is traded on a commodities exchange.

20. The financial product of claim 1 wherein the contract is a yield exchange.

21. The financial product of claim 20 wherein the yield exchange is swapped between producers.

22. The financial product of claim 20 wherein the yield exchange is traded on a commodities exchange.

23. A financial product comprising:
a commitment to cover the yield against underproduction by providing replacement.

24. The financial product of claim 23 wherein the yield is of an agricultural commodity.

25. The financial product of claim 24 wherein the agricultural commodity is corn.

26. The financial product of claim 24 wherein the agricultural commodity is soybeans.

27. The financial product of claim 24 wherein the commodity is metal.

28. The financial product of claim 27 wherein the metal is gold.

29. The financial product of claim 23 wherein the yield is of a petroleum product.

30. The financial product of claim 23 wherein the yield is of a currency.

31. The financial product of claim 30 wherein the currency is a Euro.

32. The financial product of claim 30 wherein the currency is the British pound.

33. The financial product of claim 23 wherein the yield is of a financial instrument.

34. The financial product of claim 23 wherein the yield is of a financial index.

35. The financial product of claim 23 wherein the yield is of a stock dividend.

36. The financial product of claim 23 wherein the commitment to cover the yield is on the acre yield of an agricultural commodity.

37. The financial product of claim 23 wherein the commitment to cover the yield comprises a differential matrix of ranges of yield per acre.

38. The financial product of claim 37 wherein the differential matrix sets forth increments of yield shortfalls and the price per acre that the financial protection on crop yield shortfalls costs.

39. The financial product of claim 23 wherein the commitment to cover the yield of a commodity is swapped between producers.

40. The financial product of claim 23 wherein the commitment to cover the yield of a commodity is traded on a commodities exchange.

41. A financial product comprising:
an exchange under which a future yield can be swapped with present yield.

42. The financial product of claim 41 wherein the yield is of a commodity.

43. The financial product of claim 42 wherein the commodity is an agricultural commodity.

44. The financial product of claim 43 wherein the agricultural commodity is corn.

45. The financial product of claim 43 wherein the agricultural commodity is soybeans.

46. The financial product of claim 41 wherein the yield is of a metal.

47. The financial product of claim 46 wherein the metal is gold.

48. The financial product of claim 41 wherein the yield is of a petroleum product.

49. The financial product of claim 41 wherein the yield of a currency.

50. The financial product of claim 49 wherein the currency is a Euro.

51. The financial product of claim 49 wherein the currency is the British pound.

52. The financial product of claim 41 wherein the yield is of a financial instrument.

53. The financial product of claim 41 wherein the yield is of a financial index.

54. The financial product of claim 41 wherein the yield is of a stock dividend.

55. The financial product of claim 41 further including a commitment to cover the acre yield of the future yield swap.

56. The financial product of claim 41 wherein the yield exchange is swapped between producers.

57. The financial product of claim 41 wherein the yield exchange is traded on a commodities exchange.

58. A financial product comprising:
an exchange under which future yield can be swapped for present purchasing power.

59. The financial product of claim 58 wherein the yield is of a commodity.

60. The financial product of claim 59 wherein the commodity is an agricultural commodity.

61. The financial product of claim 60 wherein the agricultural commodity is corn.

62. The financial product of claim 60 wherein the agricultural commodity is soybeans.

63. The financial product of claim 58 wherein the yield is of a metal.

64. The financial product of claim 63 wherein the metal is gold.

65. The financial product of claim 58 wherein the yield is of a petroleum prodcut.

66. The financial product of claim 58 wherein the yield is of a currency.

67. The financial product of claim 66 wherein the currency is a Euro.

68. The financial product of claim 66 wherein the currency is the British pound.

69. The financial product of claim 58 wherein the yield is of a financial instrument.

70. The financial product of claim 58 wherein the yield is of a financial index.

71. The financial product of claim 58 wherein the yield is of a stock dividend.

72. The financial product of claim 58 further including a commitment to cover the acre yield of the future yield swap.

73. The financial product of claim 58 wherein the yield exchange is swapped between producers.

74 The financial product of claim 58 wherein the yield exchange is traded on a commodities exchange.

75. A method of exchanging a financial product, comprising the steps of:
selecting a yield;
selecting a plurality of quantities of the yield;
selecting a plurality of time frames; and
enabling a first user to transfer to a second user a first quantity of the yield in a first time frame in exchange for a second quantity of the yield in a second time frame.

76. The method of claim 75 wherein each time frame represents one calendar year.

77. The method of claim 75 wherein each time frame represents one production season.

78. The method of claim 77 wherein the first time frame is the present production season.

79. The method of claim 77 wherein the first time frame is the immediately upcoming production season.

80. The method of claim 75 wherein the yield is of an agricultural commodity.

81. The method of claim 81 wherein the agricultural commodity is corn.

82. The method of claim 81 wherein the agricultural commodity is soybeans.

83. The method of claim 75 wherein the yield is of a metal.

84. The method of claim 83 wherein the metal is gold.

85. The method of claim 75 wherein the yield is of a fuel.

86. The method of claim 85 wherein the fuel is petroleum.

87. The method of claim 75 wherein the yield is of a currency.

88. The method of claim 87 wherein the currency is a Euro.

89. The method of claim 87 wherein the currency is the British pound.

90. The method of claim 75 wherein the yield is of a financial instrument.

91. The method of claim 75 wherein the yield is of a financial index.

92. The method of claim 75 wherein the yield is of a stock dividend.

93. A method of exchanging a financial product comprising:
selecting a yield;
selecting a plurality of quantities of the yield;
designated a price for each of the plurality of quantities of the yield;
enabling a first user to purchase one of the plurality of quantities for the designated price for a given time frame from a second user,
wherein if a quantity of the yield equal to the amount of the purchased one of the plurality of quantities for the given time frame is not accrued, then the second user provides the first user with a quantity of the yield equal to the portion of the purchased one of the plurality of quantities not accrued.

94. The method of claim 93 wherein the yield is of an agricultural commodity.

95. The method of claim 94 wherein the agricultural commodity is corn.

96. The method of claim 95 wherein the agricultural commodity is soybean.

97. The method of claim 93 wherein the yield is of a currency.

98. The method of claim 97 wherein the currency is the Euro.

99. The method of claim 97 wherein the currency is the British pound.

100. The method of claim 92 wherein the yield is of a metal.

101. The method of claim 100 wherein the metal is gold.

102. The method of claim 93 wherein the given time frame is one calendar year.

103. The method of claim 93 wherein the given time frame is one growing season.

104. The method of claim 93 wherein the growing season is the next growing season.

105. The method of claim 93 wherein the yield is of a petroleum product.

106. The financial product of claim 93 wherein the yield is of a stock dividend.

107. A method of exchanging a financial product comprising:
selecting a yield;
selecting a plurality of quantity differentials for the yield, each quantity differential representing a predetermined quantity of the yield;
designating a price for each of the plurality of quantity differentials; and
enabling a first user to purchase one of the plurality of quantity differentials for the designated price for a given time frame from a second user,
wherein if a quantity of the yield equal to a maximum amount of the purchased quantity differential during the given time frame is not accrued, then the second user provides the first user with a quantity of the yield equal to the portion of the purchased quantity differential not accrued.

108. The method of claim 107 wherein the yield is of an agricultural commodity.

109. The method of claim 108 wherein the agricultural commodity is corn.

110. The method of claim 108 wherein the agricultural commodity is soybean.

111. The method of claim 107 wherein the yield is of a currency.

112. The method of claim 111 wherein the currency is the Euro.

113. The method of claim 111 wherein the currency is the British pound.

114. The method of claim 107 wherein the yield is of a metal.

115. The method of claim 114 wherein the metal is gold.

116. The method of claim 107 wherein the given time frame is one calendar year.

117. The method of claim 107 wherein the given time frame is one growing season.

118. The method of claim 107 wherein the growing season is the next growing season.

119. The method of claim 107 wherein the yield is of a petroleum prodcut.

120. The method of claim 108 wherein the yield is of a stock dividend.

121. A method of exchanging a financial product comprising:
selecting a yield;
selecting a baseline quantity of the yield;
selecting a plurality of quantity differentials for the yield, each quantity differential representing a predetermined quantity of the yield below the baseline quantity;
designating a price for each of the plurality of quantity differentials; and
enabling a first user to purchase one of the plurality of quantity differentials for the designated price for a given time frame from a second user,
wherein if a quantity of the yield equal to a maximum amount of the purchased quantity differential during the given time frame is not accrued, then the second user provides the first user with a quantity of the yield equal to the portion of the purchased quantity differential not accrued.

122. The method of claim 121 wherein the yield is of an agricultural commodity.

123. The method of claim 122 wherein the agricultural commodity is corn.

124. The method of claim 122 wherein the agricultural commodity is soybean.

125. The method of claim 121 wherein the yield is of a currency.

126. The method of claim 125 wherein the currency is the Euro.

127. The method of claim 125 wherein the currency is the British pound.

128. The method of claim 121 wherein the yield is of a metal.

129. The method of claim 128 wherein the metal is gold.

130. The method of claim 121 wherein the given time frame is one calendar year.

131. The method of claim 121 wherein the given time frame is one growing season.

132. The method of claim 121 wherein the growing season is the next growing season.

133. The method of claim 121 wherein the yield is of a petroleum product.

134. The method of claim 121 wherein the yield is of a stock dividend.

135. A method of exchanging a financial product, comprising the steps of:
selecting a plurality of yields;
selecting a plurality of quantities;
selecting a plurality of time frames; and
enabling a first user to transfer to a second user a first quantity of a first yield in a first time frame in exchange for a second quantity of a second yield in a second time frame.

136. The method of claim 135, wherein the first yield and the second yield are the same type of yield.

137. The method of claim 135 wherein each time frame represents one calendar year.

138. The method of claim 135 wherein each time frame represents one production season.

139. The method of claim 138 wherein the first time frame is the present production season.

140. The method of claim 138 wherein the first time frame is the immediately upcoming production season.

141. The method of claim 135 wherein the yield is of an agricultural commodity.

142. The method of claim 141 wherein the agricultural commodity is corn.

143. The method of claim 141 wherein the agricultural commodity is soybeans.

144. The method of claim 135 wherein the yield is of a metal.

145. The method of claim 144 wherein the metal is gold.

146. The method of claim 135 wherein the yield is of a petroleum product.

147. The method of claim 135 wherein the yield is of a currency.

148. The method of claim 147 wherein the currency is a Euro.

149. The method of claim 147 wherein the currency is the British pound.

150. The method of claim 135 wherein the yield is of a financial instrument.

151. The method of claim 135 wherein the yield is of a financial index.

152. The method of claim 135 wherein the yield is of a stock dividend.

153. A method of making a financial index, comprising:
creating an underlying portfolio of yield risks; and
combining the portfolio into a cost index.

154. The method of claim 153 further wherein the step of creating an underlying portfolio of yield risks comprises creating an underlying portfolio of yield risks of an agricultural commodity.

155. The method of claim 154 further wherein the step of creating an underlying portfolio of yield risks of an agricultural commodity comprises creating an underlying portfolio of yield risks of corn.

156. The method of claim 154 further wherein the step of creating an underlying portfolio of yield risks of an agricultural commodity comprises creating an underlying portfolio of yield risks of soybeans.

157. The method of claim 154 further wherein the step of creating an underlying portfolio of yield risks comprises creating an underlying portfolio of yield risks of a metal.

158. The method of claim 157 further wherein the step of creating an underlying portfolio of yield risks of a metal comprises creating an underlying portfolio of yield risks of gold.

159. The method of claim 153 further wherein the step of creating an underlying portfolio of yield risks comprises creating an underlying portfolio of yield risks of a fuel.

160. The method of claim 159 further wherein the step of creating an underlying portfolio of yield risks of a fuel comprises creating comprises creating an underlying portfolio of yield risks of petroleum.

161. The method of claim 153 further wherein the step of creating an underlying portfolio of yield risks comprises creating an underlying portfolio of yield risks of currency.

162. The method of claim 161 further wherein the step of creating an underlying portfolio of yield risks of a currency comprises creating an underlying portfolio of yield risks of Euros.

163. The method of claim 161 further wherein the step of creating an underlying portfolio of yield risks of a currency comprises creating an underlying portfolio of yield risks of British pounds.

164. The method of claim 153 further wherein the step of creating an underlying portfolio of yield risks comprises creating an underlying portfolio of dividend risks of stock.

165. A financial index, comprising:
a plurality of quantities of a commodity; and
a plurality of time frames in which the commodity will be produced;
wherein a first user and a second user may exchange quantities of the commodity based upon the matrix.
creating an underlying portfolio of yield risks; and
combining the portfolio into a cost index.

166. The financial index of claim 165 wherein the yield risks are of an agricultural commodity.

167. The financial index of claim 166 wherein the agricultural commodity is corn.

168. The financial index of claim 166 wherein the agricultural commodity is soybeans.

169. The financial index of claim 166 wherein the commodity is metal.

170. The financial index of claim 169 wherein the metal is gold.

171. The financial index of claim 165 wherein the yield is of a petroleum product.

172. The financial index of claim 165 wherein the yield is of a currency.

173. The financial index of claim 172 wherein the currency is a Euro.

174. The financial index of claim 172 wherein the currency is the British pound.

175. The financial index of claim 165 wherein the yield is of a financial instrument.

176. The financial index of claim 165 wherein the yield is of a financial index.

177. The financial index of claim 165 wherein the yield is of a stock dividend.
